(19) United States
(12) Patent Application Publication
(10) Pub. No.: US 2021/0326666 A1
(43) Pub. Date: Oct. 21, 2021

(54) RFID TAG, RFID SYSTEM USING SAME, AND CONTAINER

(71) Applicant: PHC HOLDINGS CORPORATION, Tokyo (JP)

(72) Inventors: Kiminori MIZUUCHI, Osaka (JP); Yorio TAKAHASHI, Ehime (JP); Seiji MURAKAMI, Ehime (JP)

(21) Appl. No.: 17/365,136

(22) Filed: Jul. 1, 2021

Related U.S. Application Data
(63) Continuation of application No. PCT/JP2019/046593, filed on Nov. 28, 2019.

(30) Foreign Application Priority Data
Jan. 8, 2019 (JP) 2019-001468

(51) Int. Cl. G06K 19/07

(52) U.S. Cl. CPC G06K 19/0709; G06K 19/0723

(57) ABSTRACT

An RFID tag is provided with an antenna for generating electric power from a carrier wave by a received electromagnetic wave, a semiconductor integrated circuit which is operated by the electric power supplied from the antenna; and a heat generation element for generating heat by the electric power supplied from the antenna, and heating the semiconductor integrated circuit.

### TECHNICAL FIELD

The present disclosure relates to an RFID tag, and an RFID system and a container using the RFID tag.

### BACKGROUND ART

In the related art, RFID tags have been used in various applications. For example, PTL 1 discloses a technology for attaching an RFID tag to a sample container such as a test tube or paper cup containing a sample, and reading the sample's information from the RFID tag.

### CITATION LIST

### Patent Literature

PTL 1

Japanese Patent Application Laid-Open No. 2018-112882

### SUMMARY OF INVENTION

### Technical Problem

When RFID tags are attached to items such as cryopreservation containers for storing cells and bacteria at ultra-low temperatures (e.g., −196° C., the temperature of liquid nitrogen), the following problems exist. Specifically, the semiconductor device of the semiconductor integrated circuit (hereinafter referred to as “IC chip”) used in the RFID tag will not operate properly as a semiconductor due to a decrease in its carrier density at ultra-low temperatures. As a result, it becomes impossible to read information from the RFID tag and to write information to the RFID tag.

An object of the present disclosure is to provide an RFID tag that can be used at an ultra-low temperature, and an RFID system and a container that include the RFID tag.

### Solution to Problem

To solve the above-mentioned problems of the related art, an RFID tag of an embodiment of the present disclosure includes: an antenna configured to generate power from received carrier waves composed of electromagnetic waves; a semiconductor integrated circuit configured to operate with the power supplied from the antenna; and a heater device configured to generate heat with the power supplied from the antenna to heat the semiconductor integrated circuit.

To solve the above-mentioned problems of the related art, an RFID system of an embodiment of the present disclosure includes: the RFID tag; and a communication apparatus configured to oscillate the carrier waves composed of the electromagnetic waves, and perform at least one of an operation of writing information to the RFID tag and an operation of reading information from the RFID tag.

To solve the above-mentioned problems of the related art, a container of an embodiment of the present disclosure includes: a container main body comprising a housing part; and the RPM tag attached to the container main body.

### Advantageous Effects of Invention

According to the present disclosure, it is possible to provide an RFID tag that can be used at an ultra-low temperature, and an RFID system and a container that use the RFID tag.

### BRIEF DESCRIPTION OF DRAWINGS

FIG. 1 is a schematic view illustrating a configuration of an RFID system of Embodiment 1 of the present disclosure;

FIG. 2 is a schematic circuit diagram illustrating a configuration of an RFID tag of Embodiment 1 of the present disclosure;

FIG. 3 is a schematic circuit diagram illustrating a configuration of an RFID tag of Embodiment 2 of the present disclosure; FIG. 4 is a schematic circuit diagram illustrating a configuration of an RFID tag of

Embodiment 3 of the present disclosure;

FIG. 5 is a schematic circuit diagram illustrating a configuration of an RFID tag of Embodiment 4 of the present disclosure;

FIG. 6 is a schematic circuit diagram illustrating a configuration of an RFID tag of Embodiment 5 of the present disclosure;

FIG. 7 is a schematic circuit diagram illustrating a configuration of an RFID tag of Embodiment 6 of the present disclosure;

FIG. 8 is a schematic circuit diagram illustrating a configuration of an RFID ag of Embodiment 7 of the present disclosure;

FIG. 9 is a schematic longitudinal sectional view illustrating a modification of a container of the present disclosure;

FIG. 10A is a schematic longitudinal sectional view illustrating a modification of a container of the present disclosure;

FIG. 10B is a diagram corresponding to an enlarged view of part X of FIG. 10A;

FIG. 10C is a diagram corresponding to an enlarged view of part X of FIG. 10A;

FIG. 10D is a diagram corresponding to an enlarged view of part X of FIG. 10A;

FIG. 11 is a schematic longitudinal sectional view illustrating a modification of a container of an embodiment of the present disclosure;

FIG. 12A is a schematic longitudinal sectional view illustrating a modification of a container of an embodiment of the present disclosure; and

FIG. 12B is a schematic longitudinal sectional view illustrating a modification of a container of an embodiment of the present disclosure.

### DESCRIPTION OF EMBODIMENTS

An RFID tag, and an RFID system and a container using the RFID tag according to embodiments of the present disclosure are described below with reference to the drawings.

The following embodiments are merely examples, and do not preclude the application of various variations and technologies not explicitly described in the following embodiments. In addition, each configuration of each embodiment can be implemented with various variations to the extent that it does not deviate from the purpose thereof. Furthermore, each configuration of each embodiment can be discarded or selected as necessary, or can be combined as appropriate.

In all drawings for describing the embodiments, the same elements are basically denoted with the same sign and their descriptions may be omitted.

### 1. Embodiment 1

### 1.-1. Configuration

### 1-1-1. Configuration of RFID System

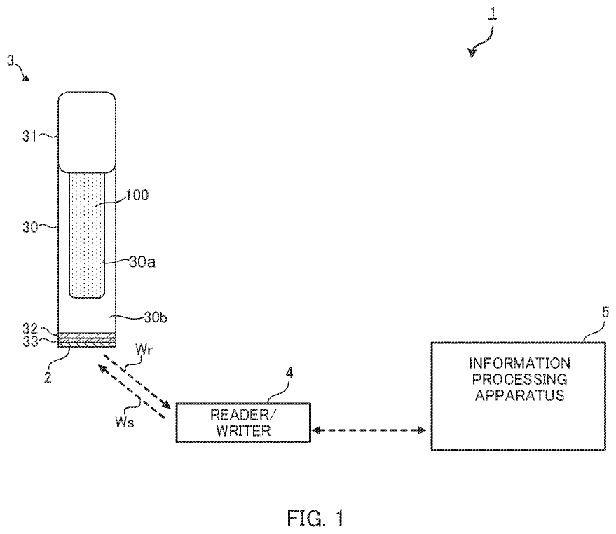

A general configuration of an RFID system of Embodiment 1 of the present disclosure is described below with reference to FIG. 1. FIG. 1 is a schematic view illustrating a configuration of the RFID system of Embodiment 1 of the present disclosure. Note that FIG. 1 illustrates a vertical cross-section of container 3 for convenience.

As illustrated in FIG. 1, RFID system 1 includes container 3 to which RFID tag 2 is attached, reader/writer 4, and information processing apparatus 5.

In the present embodiment, container 3 houses sample 100. Sample 100 is, for example, a living tissue, cell, sperm, egg, blood, or DNA. For example, sample 100 housed in container 3 is stored in a frozen state in a storage apparatus using liquid nitrogen at an ultra-low temperature (e.g., approximately −196° C.) (hereinafter referred to also as “ultra-low temperature storage apparatus”). Although not illustrated in the drawing in FIG. 1, container 3 is handled in a state where a plurality of containers 3 is stored in a sample rack, and is housed in an ultra-low temperature storage apparatus in the state where they are stored in the sample rack.

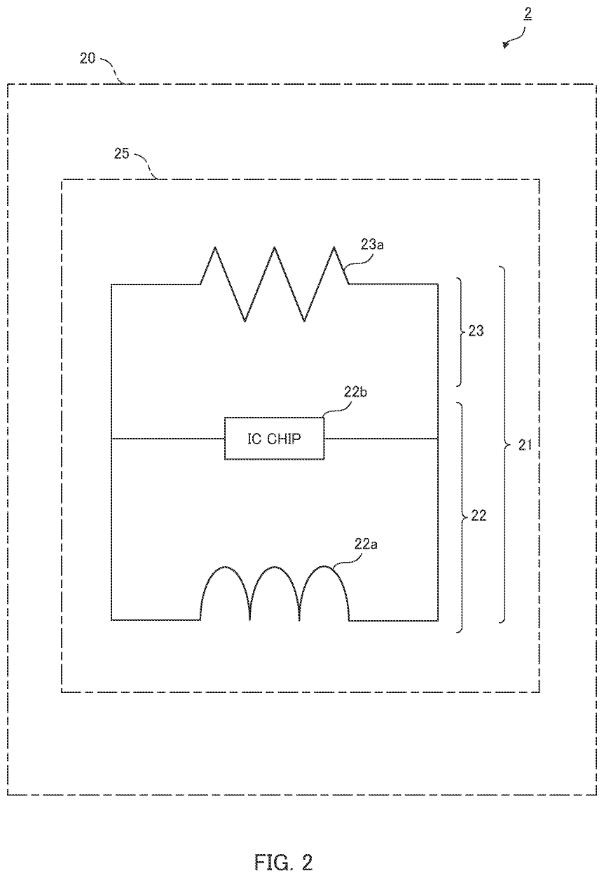

Reader/writer 4 constitutes the communication apparatus of the embodiment of the present disclosure, and reads information from RFID tag 2 and writes information to RFID tag 2 by communicating with RFID tag 2. Specifically, when writing information to RFID tag 2 (hereinafter referred to also as “write information”), reader/writer 4 oscillates carrier wave Ws composed of electromagnetic waves with the write information superimposed by various modulations. When reading information from RFID tag 2 (hereinafter referred to also as “read information”), reader/writer 4 drives the antenna 22a (see FIG. 2) described below by supplying electric power to the RFID tag 2 using carrier wave Ws to operate the RFID tag 2, receives the reflected wave Wr oscillated by the antenna 22a, and reads the read information accompanied by this reflected wave Wr.

In RFID tag 2, ID information for specifying RFID tag 2 is written in advance, and the read information includes at least this ID information. In addition, in RFID tag 2, a recording region for recording various information related to sample 100 may be provided in advance.

In the case where a plurality of RFID tags 2 is present in a range where carrier wave Ws of reader/writer 4 reaches, reading is performed using a mechanism called anti-collision. The anti-collision operation, for example, specifies a specific bit of ID information of each tag as a time slot. For example, when two bits are specified as a time slot, the reflected wave Wr is transmitted by shilling the response timing on the tag side in accordance with the four types of bit data (00, 01, 10, and 11), to avoid interference. If a plurality of RFID tags 2 responds in the same time slot, interference will occur and the reading cannot be performed normally. When only one RFID tag 2 responds in one time slot, the data can be read normally, and therefore a sleep command to not oscillate the reflected wave Wr for a certain period of time is issued to that RFID tag 2 by specifying the ID. In the case where reading cannot be normally performed even when reflection wave Wr has been received, it is highly possible that a plurality of RFID tags 2 is present in the same time slot, and therefore carrier wave Ws is re-transmitted by re-specifying two bits different from the earlier information as the time slot. Then, only the RFID tag 2 (RFID tag 2 that is not yet read) other than RFID tag 2 that has been read oscillates reflection wave Wr, and thus, all tag information is read by repeating the same operation until there is no time slot in which reading cannot be performed due to a plurality of RFID tags 2 responding in the same time slot. In the case where writing is required, the ID of the RFID tag 2 to be written is specified after obtaining the ID information of all current readable RFID tags 2, and the carrier wave Ws containing the writing command and writing data is oscillated to perform writing to one RFID tag 2 at a time.

Information processing apparatus 5 is connected to reader/writer 4 in a wired or wireless manner, and exchanges information with RFID tag 2 through reader/writer 4. Specifically, information processing apparatus 5 receives read information from RFID tag 2 through reader/writer 4, and transmits write information to container 3 RFID tag 2 through reader/writer 4.

Note that information processing apparatus 5 includes a storage apparatus (not illustrated in the drawing), and the read information and the write information are classified by ID information, or in other words, by container 3, and stored in the storage apparatus. In addition, information processing apparatus 5 includes a display device (not illustrated in the drawing) and an input apparatus (not illustrated in the drawing). The read information is displayed on the display device and the write information is input from the input apparatus.

### 1-1-2. Configuration of Container

A configuration of container 3 is described below with reference to FIG. 1 again.

Container 3 illustrated in FIG. 1 includes container main body 30, lid 31, heat insulating layer 32, shielding layer 33, and RFID tag 2.

Container main body 30 has a bottomed cylindrical shape that is long in the axial direction with an opening at its one end, and sample 100 is housed in housing part 30a disposed inside.

Lid 31 seals the opening of container main body 30. Lid 31 has a substantially columnar shape, and is detachably attached to container main body 30 such that the lower end as its one end in the axis direction closes the opening.

Heat insulating layer 32 is a sheet member formed of a highly heat insulating material. Shielding layer 33 is a sheet member formed of a material that highly shields carrier wave Ws. RFID tag 2 is attached to container main body 30 through heat insulating layer 32 and shielding layer 33. In the present embodiment, heat insulating layer 32 is provided at the bottom surface (outer surface) of bottom portion 30b of container main body 30, shielding layer 33 is provided at the bottom surface of heat insulating layer 32, and RFID tag 2 is provided at the bottom surface of shielding layer 33.

The reason why heat insulating layer 32 and shielding layer 33 are provided is as follows.

As described later, RFID tag 2 includes heating circuit 23. When the heat generated at heating circuit 23 is transmitted to sample 100 of housing part 30a through bottom portion 30b, thermal denaturation of sample 100 may occur. In view of this, heat insulating layer 32 is provided between RFID tag 2 and container main body 30 that houses sample 100 such that heat insulating layer 32 suppresses the heat transmission from RFID tag 2 to sample 100.

Depending on sample 100, the possibility of being affected by the carrier wave Ws cannot be excluded. In view of this, shielding layer 33 is provided between RFID tag 2 that receives carrier wave Ws and container main body 30 that houses sample 100 such that shielding layer 33 suppresses arrival of carrier wave Ws at sample 100.

In addition, the thickness of bottom portion 30b is relatively increased to relatively increase the distance between RFID tag 2 and housing part 30a such that the influence of carrier wave Ws and the heat transfer from heating circuit 23 of RFID tag 2 are further suppressed.

### 1-1-3. Configuration of RFID Tag

A configuration of the RFID tag of Embodiment 1 of the present disclosure is described below with reference to FIG. 2. FIG. 2 is a schematic circuit diagram illustrating a configuration of the RFID tag of Embodiment 1 of the present disclosure.

RFID tag 2 includes base material 20, tag circuit 21. sheet-shaped heat insulator 25 (hereinafter referred to as “heat insulating sheet 25”), and a two-sided adhesive sheet not illustrated in the drawing. Tag circuit 21 includes RFID circuit 22 and heating circuit 23, such that circuits 22 and 23 are connected in parallel. That is, tag circuit 21 is a circuit in which RFID circuit 22 and heating circuit 23 are integrated with each other.

Each tag circuit 21 is fixed to one surface of base material 20 by, for example, being bonded to the one surface. Heat insulating sheet 25 is provided at one surface of base material 20 in such a manner as to cover tag circuit 21. Further, the two-sided adhesive sheet is bonded to one surface of base material 20 in such a manner as to cover heat insulating sheet 25, and RFID tag 2 is bonded to shielding layer 33 of container 3 with two-sided adhesive sheet.

RFID circuit 22 includes antenna 22a and semiconductor integrated circuit 22b (hereinafter referred to also as “IC chip 22b”).

Antenna 22a is an electromagnetic induction coil, and when it receives a carrier wave of first frequency f1, which is the resonance frequency of tag circuit 21, from reader/writer 4, an induced electromotive force (hereinafter simply referred to also as “power”) is generated at antenna 22a. This power is used as the driving power for both RFID circuit 22 and heating circuit 23. That is, single antenna 22a is used as a common power generation source of RFID circuit 22 and heating circuit 23.

RFID circuit 22 includes a controller, a memory, and the like, which are not illustrated in the drawing. The controller is operated with the power supplied from antenna 22a. When receiving carrier wave Ws (regeneration command carrier wave Ws) on which a signal requesting the transmission of read information is superimposed, the controller reads the corresponding read information from the memory and oscillates reflection wave Wr at antenna 22a. This reflection wave Wr includes the read information. In addition, when carrier wave Ws (write command carrier wave Ws) with a command signal requesting writing, write information and individual ID information of RFID tag 2 as the writing object is received and it matches its ID information, the controller writes the write information in the memory provided in RFID circuit 22.

Heating circuit 23 is a circuit for heating IC chip 22b of RFID circuit 22. Specifically, heating circuit 23 includes heater device 23a.

Heater device 23a includes a resistance heater in the present embodiment, and is in a state where it is thermally coupled with IC chip 22b of RFID circuit 22. When the power is supplied from antenna 22a to heater device 23a, heater device 23a generates heat and heats IC chip 22b.

### 1-2. Operation and Effect

According to Embodiment 1 of the present disclosure, the following operation and effect are achieved.

(1) Heater device 23a generates heat with the power supplied from antenna 22a, and IC chip 22b is heated. Thus, in even in the case where sample 100 is provided in container 3 and is used in an ultra-low temperature, it is possible to suppress reduction of the carrier density of the semiconductor devices accumulated in IC chip 22b at an ultra-low temperature. So, it is possible to suppress resulting abnormal operation of the semiconductor devices as a semiconductor. Thus, RFID tag 2 can be set to a state where it normally operates even at an ultra-low temperature, and RFID tag 2 can be used at an ultra-low temperature at which typical semiconductors cannot normally operate.

(2) Since RFID circuit 22 and heating circuit 23 share a single antenna 22a, the configuration of tag circuit 21 can be simplified.

(3) Since heating circuit 23 does not include a switching circuit such as a transistor and an FET including a semiconductor material that does not normally operate at an ultra-low temperature, and IC chip 22b can be heated even at an ultra-low temperature at which IC chip 22b does not operate, and thus, the temperature of IC chip 22b can be increased to its operative temperature.

(4) Since heating circuit 23 and RFID circuit 22 including IC chip 22b are covered with heat insulating sheet 25, the heat dissipation from both of circuits 22 and 23 can be suppressed. Thus, heating circuit 23 can efficiently and immediately heat only RFID circuit 22. In addition, IC chip 22b whose temperature is increased to a temperature where it can perform normal operation can be maintained in the state where IC chip 22b can perform normal operation for a certain time.

(5) Since in container 3, heat insulating layer 32 is provided between RFID tag 2 and container main body 30, heat insulating layer 32 can suppress the transmission of the heat from heating circuit 23 of RFID tag 2 to sample 100 housed in container main body 30, and thus thermal denaturation of sample 100 can be prevented.

(6) Since in container 3, shielding layer 33 is provided between RFID tag 2 and container main body 30, shielding layer 33 can suppress the transmission of carrier wave Ws from reader/writer 4 to sample 100 housed in container main body 30, and it is possible to prevent carrier wave Ws from affecting sample 100.

### 2. Embodiment 2

### 2-1. Configuration

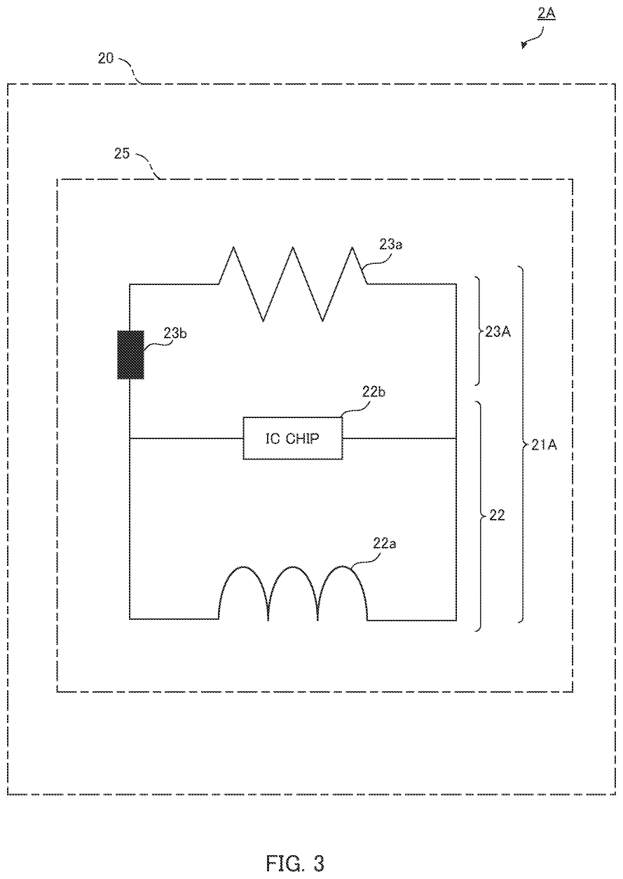

An RFID system, an RFID tag and a container of Embodiment 2 of the present disclosure are different from those of Embodiment 1 only in the configuration of the heating circuit of the RFID tag, and other configurations are the same as those of Embodiment 1, A configuration of the RFID tag of Embodiment 2 of the present disclosure is described below with reference to FIG. 3. FIG. 3 is a schematic view illustrating a configuration of the RFID tag of Embodiment 2 of the present disclosure.

Tag circuit 21A of RFID tag 2A of the present embodiment includes RFID circuit 22 and heating circuit 23A. Heating circuit 23A of RFID tag 2A of the present embodiment is different from heating circuit 23 of RFID tag 2 of Embodiment 1 in that it is provided with PTC thermistor device 23b (impedance device).

PTC thermistor device 23b is connected in series with heater device 23a, and thermally connected with heater device 23a and IC chip 22b. This PTC thermistor device 23b has a property in which the impedance decreases as the temperature decreases, and the impedance abruptly increases when the temperature becomes equal to or higher than a predetermined temperature. Note that the state where it is thermally connected means that there is a certain heat transmission between members physically connected with each other. Preferably, PTC thermistor device 23b is connected to heater device 23a and IC chip 22b such that a thermal conductivity between PTC thermistor device 23b and heater device 23a is a favorable thermal conductivity, and a thermal conductivity between PTC thermistor device 23b and IC chip 22b is a favorable thermal conductivity, in order to provide a favorable responsiveness.

When temperature t1 of IC chip 22b is lower than threshold value t0 (t1≤t0), the temperature of PTC thermistor device 23b is also relatively low and the impedance of PTC thermistor device 23b is low. In view of this, the power from antenna 22a is supplied to heater device 23a through PTC thermistor device 23b and heater device 23a generates heat and heats IC chip 22b. Meanwhile, when temperature t1 of IC chip 22b is higher than threshold value t0 (t1>t0), the impedance of PIC thermistor device 23b is a large value. As a result, the power from antenna 22a is not supplied to heater device 23a because of PIC thermistor device 23b.

Here, PTC thermistor device 23b is selected such that IC chip 22b normally operates, That is, the state where temperature t1 of IC chip 22b is equal to or lower than threshold value t0 is a state of an ultra-low temperature at which IC chip 22b may not normally operate. In addition, the state where temperature t1 of IC chip 22b is higher than threshold value t0 is a state of a high temperature at which IC chip 22b can normally operate.

That is, at an ultra-low temperature state at which IC chip 22b does not normally operate, heating circuit 23 heats IC chip 22b, whereas at a high temperature at which IC chip 22b can normally operate, heating circuit 23 does not heat IC chip 22b more than necessary.

After the heating at heater device 23a is stopped, IC chip 22b generates its own heat along with its operation, and thus IC chip 22b is maintained at a high temperature state through that heat generation. In other words, the heat dissipation of IC chip 22b after the stoppage of heater device 23a is offset by the heat generation of IC chip 22b itself.

Note that the high temperature state means a temperature relatively higher than an ultra-low temperature at which it may not normally operate below the lower limit of the guaranteed operating temperature of IC chip 22b, and the guaranteed operating temperature lower limit of a common semiconductor circuit is approximately −40° C., for example.

In addition, heating circuit 23A does not include a switching circuit such as a FET and a transistor including a semiconductor material that does not normally operate at an ultra-low temperature, as in heating circuit 23 of Embodiment 1.

Other configurations are the same as those of RFID tag 2 of Embodiment 1, and therefore the description thereof is omitted.

### 2-2. Operation and Effect

According to Embodiment 2 of the present disclosure, the following operation and effect are achieved in addition to the operation and effect of Embodiment 1.

In heating circuit 23A, PTC thermistor device 23b is connected in series with heater device 23a. Through heat generation of heater device 23a, the temperature increases not only at IC chip 22b, but also at PTC thermistor device 23b. At PTC thermistor device 23b, the impedance of PTC thermistor device 23b increases as the temperature of PTC thermistor device 23b increases, as a result, the power supply to heater device 23a reduces. Thus, in a high temperature state where IC chip 22b can normally operate, heater device 23a can be prevented from heating IC chip 22b more than necessary. Furthermore, the thermal denaturation of sample 100 in the container can be further suppressed.

### 3. Embodiment 3

### 3-1. Configuration

An RFID system, an RFID tag and a container of Embodiment 3 of the present disclosure are different from those of the embodiments in the configurations of the reader/writer and the RFID tag as components of the RFID system, and other configurations are the same as those of the embodiments. Configurations of an RFID tag and a reader/writer of Embodiment 3 of the present disclosure are described below with reference to FIG. 4. FIG. 4 is a schematic view illustrating a configuration of the RFID tag of Embodiment 3 of the present disclosure.

Tag circuit 218 of RFID tag 2B of the present embodiment includes RFID circuit 22B and heating circuit 23B. RFID tag 2B of the present embodiment is different from RFID tag 2A of Embodiment 2 in that RFID circuit 22B and heating circuit 23B are provided with capacitors 22c and 23c.

In RFID circuit 22B, capacitor 22c is provided in parallel with antenna 22a and IC chip 22b between antenna 22a and IC chip 22b. In heating circuit 23B, capacitor 23c is provided in parallel with heater device 23a to sandwich heater device 23a between it and IC chip 22b.

Here, resonance frequency f of tag circuit 21B is represented by the following Equation (1). In the following Equation (1), L represents the inductance of tag circuit 21B, and C represents the electrical capacitance of the capacitor of tag circuit 21B.

$$\begin{matrix}[ 1 ] & \\ f = \frac{1}{2 π \sqrt{L \times C}} & ( Equation 1 )\end{matrix}$$

In a high temperature state of IC chip 22b, no power is supplied to heating circuit 23B because of PIC thermistor device 23b, and the power is supplied only to RFID circuit 22B. As a result, capacitor 23c of heating circuit 23B does not serve its function, and only capacitor 22c of RFID circuit 22B serves its function. Accordingly, resonance frequency f1 of tag circuit 21B in a high temperature state of IC chip 22b is represented by the following Equation (2) using only electrical capacitance C1 of capacitor 22c.

$$\begin{matrix}[ 2 ] & \\ f 1 = \frac{1}{2 π \sqrt{L \times C 1}} & ( Equation 2 )\end{matrix}$$

On the other hand, in a low temperature state of IC chip 22b, the power is supplied also to heating circuit 2313 in addition to RFID circuit 22B, and thus both capacitor 22c of RFID circuit 22B and capacitor 23c of heating circuit 23B serve their functions. Accordingly, resonance frequency f2 of tag circuit 21B in a low temperature state of IC chip 22b is represented by the following Equation (3) using electrical capacitance C1 of capacitor 22c and electrical capacitance C2 of capacitor 23c.

$$\begin{matrix}[ 3 ] & \\ f 2 = \frac{1}{2 π \sqrt{L \times ( C 1 + C 2 )}} & ( Equation 3 )\end{matrix}$$

As described above, resonance frequency f changes in accordance with whether the temperature of IC chip 22b is greater than threshold value to or not.

Reader/writer 4B is configured to switch the frequency of carrier wave Ws between the resonance frequency f1 (hereinafter also denoted as “first frequency f1”) and the resonance frequency 12 (hereinafter also denoted as “second frequency f2”). Note that in the case where first frequency f1 and second frequency f2 relatively close to each other, reader/writer 413 switches the frequency of carrier wave Ws to first frequency f1 or second frequency f2 by switching the oscillation frequency of the source oscillation circuit. In the case where first frequency f1 and second frequency f2 are largely different from each other, reader/writer 4B needs to separately include an antenna for oscillating first frequency f1 and an antenna for oscillating second frequency f2.

When reader/writer 4B reads information from RFID tag 2B, reader/writer 4B oscillates carrier wave Ws with the frequency set to first frequency f1. When reader/writer 4B receives reflection wave Wr associated with read information (when the information is successfully read) from RFID tag 2B in response to this oscillation of carrier wave Ws, the frequency of carrier wave Ws is thereafter maintained at first frequency f1. On the other hand, when reader/writer 4B has not received reflection wave Wr associated with read information (when no reflection wave Wr itself has been detected) from RFID tag 2B in response to the oscillation of carrier wave Ws, reader/writer 4B switches the frequency of carrier wave Ws to second frequency f2 once and oscillates it for a predetermined time, and then, resets the frequency to first frequency f1.

In addition, when reader/writer 4B writes information to RFID tag 2B, reader/writer 4B oscillates carrier wave Ws with the frequency set to first frequency f1. When reader/writer 4B has successfully written information to RFID tag 2B in response to this oscillation of carrier wave Ws, the frequency of carrier wave Ws is thereafter maintained at first frequency f1. On the other hand, when reader/writer 4B has not successfully written information in response to the oscillation of carrier wave Ws, reader/writer 4B switches the frequency of the carrier wave Ws to second frequency f2 once and oscillates it for a predetermined time, and then, resets the frequency to first frequency f1. Note that reader/writer 4B confirms the success of writing of information to RFID tag 2B by receiving a flag indicating the success of writing of information from RFID tag 2B. Alternatively, or in conjunction with this, it is possible to determine that reader/writer 4B has successfully written information to RFID tag 2B when reader/writer 4B transmits regeneration command carrier wave Ws and then receives the information from RFID tag 2B.

A reason for this is described below. In a low temperature state of IC chip 22b, the resonance frequency of tag circuit 21B becomes frequency f2 as described above. As such, only slight power is generated at antenna 22a even when carrier wave Ws of frequency f1 is received, and consequently neither RFID circuit 22B nor heater device 23a operates.

On the other hand, when carrier wave Ws of frequency f2 is received, power is generated at antenna 22a, and as a result, heater device 23a, which does not include a semiconductor material, generates heat and heats IC chip 22b although IC chip 22b does not operate since it is in a low temperature state.

That is, when IC chip 22b is in a low temperature state, neither reading nor writing of information cannot be performed, however, by setting the frequency of carrier wave Ws to second frequency f2, the temperature of IC chip 22b can be increased by heating it.

On the other hand, when IC chip 22b is in a high temperature state, the resonance frequency of tag circuit 21B becomes frequency f1 as described above. Thus, although antenna 22a generates almost no power even when carrier wave Ws of frequency f2 is received; however, when carrier wave Ws of frequency f1 is received, power is supplied from antenna 22a to IC chip 22b, and IC chip 22b can operate since it becomes in a high temperature state.

That is, when IC chip 22b is in a high temperature state, neither reading nor writing of information can be performed and IC chip 22b is not heated even when the frequency of carrier wave Ws is set to frequency f2. Meanwhile, by setting the frequency of carrier wave Ws to frequency f1, reading and writing of information can be performed. In other words, when reading and writing of information from/to RFID tag 2B at reader/writer 4B is enabled, it is possible to determine that IC chip 22b is in a high temperature state and that heating of IC chip 22b by heating circuit 23B is unnecessary.

In view of this, when the frequency of carrier wave Ws is set to frequency f1 and reading or writing of information from/to RFID tag 2B is failed, reader/writer 4B determines that IC chip 22b is in a low temperature state, and switches the frequency of carrier wave Ws to frequency f2 and heats IC chip 22b. On the other hand, when the frequency of carrier wave Ws is set to frequency f1 and reading or writing of information from/to RFID tag 2B is succeeded, reader/writer 4B determines that IC chip 22b is in a high temperature state, and the frequency of carrier wave Ws is maintained at first frequency f1.

Note that in the present embodiment, heating circuit 23B including capacitor 23c does not include a switching circuit such as a transistor and an FET including a semiconductor material that does not normally operate in an ultra-low temperature.

Other configurations are the same as those of RFID tag 2 of Embodiment 1, and therefore the description thereof is omitted.

### 3-2. Operation and Effect

According to Embodiment 3 of the present disclosure, the same operation and effect as those of Embodiment 2 can be achieved with the above-described configuration.

Further, a desired value can be set to the resonance frequency of the entire circuit when heating circuit 23B operates in a low temperature state. Therefore, it is possible to set the frequency f1 and frequency f2 to values sufficiently far apart to operate completely independently, and to set the frequency f1 and frequency f2 arbitrarily to frequencies in the frequency band that can be used in each country according to the Radio Law and other laws and regulations.

### 4. Embodiment 4

### 4-1. Configuration

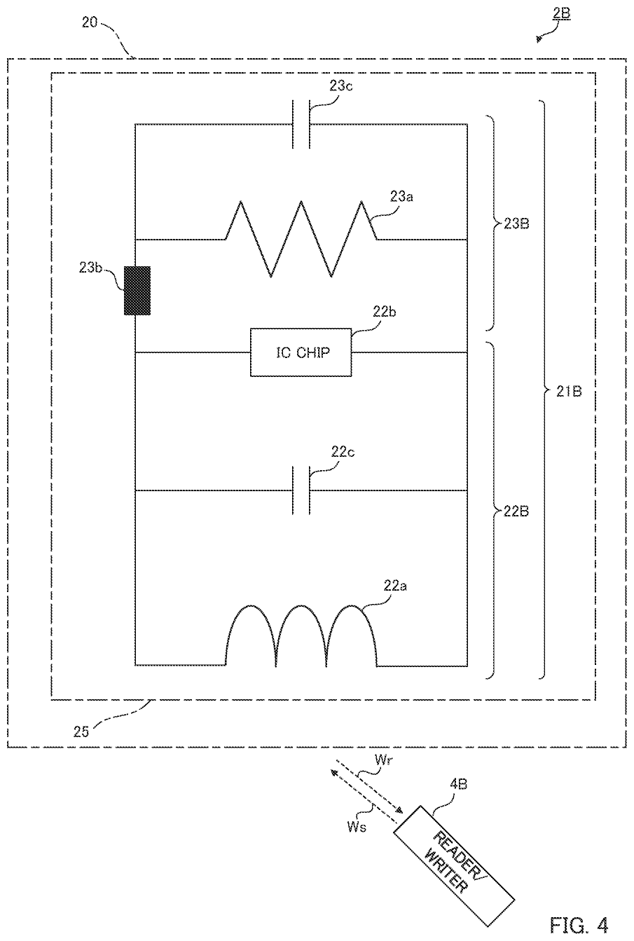

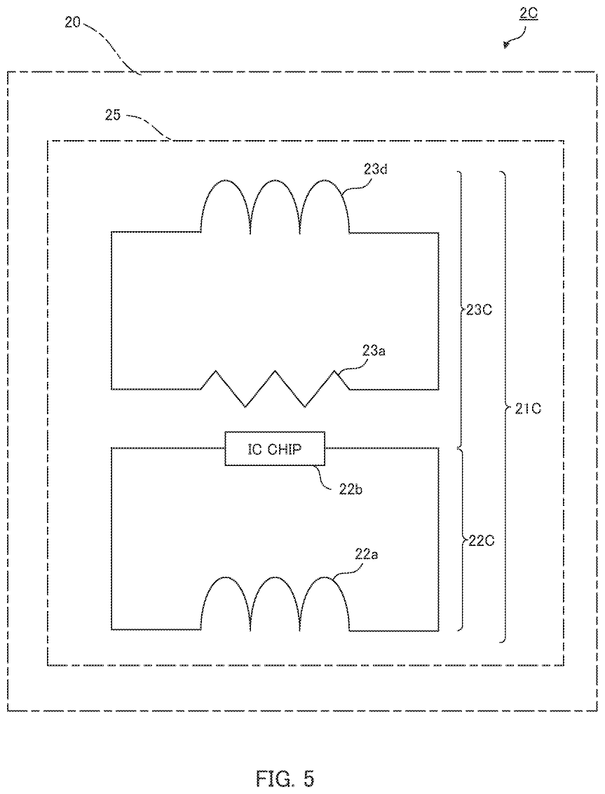

An RFID system, an RFID tag and a container of Embodiment 4 of the present disclosure are different from those of Embodiment 1 in the configuration of the tag circuit of the RFID tag, and other configurations are the same as those of Embodiment 1. A configuration of the RFID tag of Embodiment 4 of the present disclosure is described below with reference to FIG. 5. FIG. 5 is a schematic view illustrating a configuration of the RFID tag of Embodiment 4 of the present disclosure.

Tag circuit 21C of RFID tag 2C of the present embodiment includes RFID circuit 22C and heating circuit 23C. RFID circuit 22C and heating circuit 23C are configured as circuits independently of (separated from) each other. Tag circuit 21C is different from tag circuit 21 of Embodiment 1 including RFID circuit 22 and heating circuit 23 integrated with each other in that RFID circuit 22C and heating circuit 23C are independently of each other. RFID circuit 22C is a known typical RFID circuit, and includes antenna 22a and IC chip 22b. Antenna 22a is a coil-shaped antenna, and, when carrier wave Ws of the same frequency as the resonance frequency of RFID circuit 22C is received from reader/writer 4 (see FIG. 1), power is generated at antenna 22a. This power is used as driving power of IC chip 22b.

Heating circuit 23C includes heater device 23a and antenna 23d. Neither heater device 23a nor antenna 23d includes a semiconductor material, and in turn, heating circuit 23C does not include a semiconductor material.

Antenna 23d is the same as antenna 22a. Specifically, antenna 23d is a coil-shaped. antenna, and, when carrier wave Ws of the same frequency as the resonance frequency of heating circuit 23C is received, power is generated at antenna 23d. This power is used as power for causing heater device 23a to generate heat.

In the present embodiment, the resonance frequencies of RFID circuit 22C and heating circuit 23C are the same (or substantially the same). Thus, when receiving a carrier wave of the same frequency (or substantially the same frequency) as the resonance frequency oscillated at reader/writer 4, RFID circuit 22C and heating circuit 23C simultaneously operate.

### 4-2. Operation and Effect

According to Embodiment 4 of the present disclosure, the following operation and effect are achieved in addition to the same operation and effect as those of Embodiment 1.

RFID circuit 22C and heating circuit 23C are provided as independent circuits. Thus, according to Embodiment 4 of the present disclosure, it is possible to achieve manufacture utilizing RFID circuit 22C, which is a known typical RFID circuit.

### 5. Embodiment 5

### 5-1. Configuration

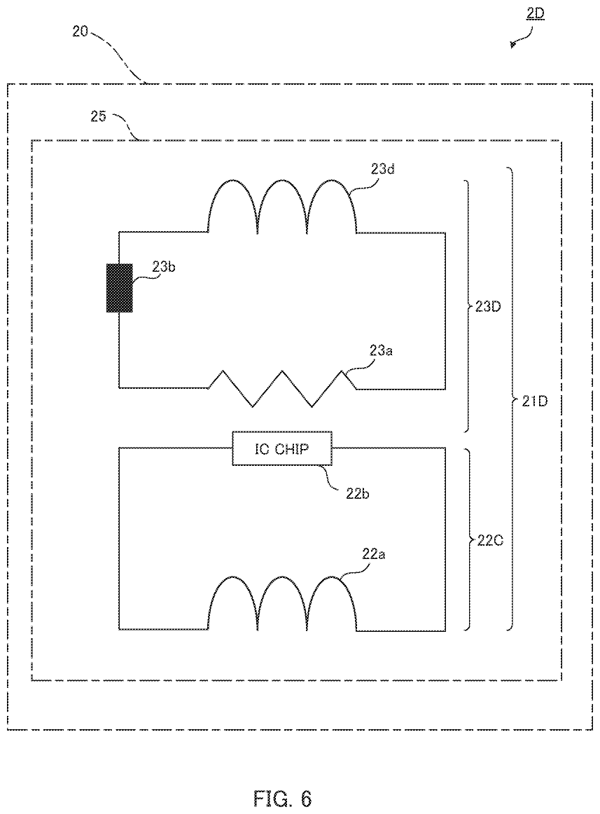

An RFID system, an RFID tag and a container of Embodiment 5 of the present disclosure are different from those of Embodiment 4 only in the configuration of the heating circuit of the RFID tag, and other configurations are the same as those of Embodiment 4. A configuration of RFID tag of Embodiment 5 of the present disclosure is described below with reference to FIG. 6. FIG. 6 is a schematic view illustrating a configuration of the RFID tag of Embodiment 5 of the present disclosure.

Tag circuit 21D of RFID tag 2D of the present embodiment includes RFID circuit 22C and heating circuit 23D. Heating circuit 23D of RFID tag 2D of the present embodiment is different from heating circuit 23C of RFID tag 2C of Embodiment 4 illustrated in FIG. 5 in that PTC thermistor device 23b is provided in series with heater device 23a.

Other configurations are the same as those of RFD tag 2C of Embodiment 4, and therefore the description thereof is omitted.

### 5-2. Operation and Effect

According to Embodiment 5 of the present disclosure, with PTC thermistor device 23b provided in heating circuit 23D, it is possible to prevent unnecessary heating of IC chip 22b and to suppress the thermal denaturation of sample 100 in the container while achieving the same operation and effect as those of Embodiment 4, as in Embodiment 2.

### 6. Embodiment 6

### 6-1. Configuration

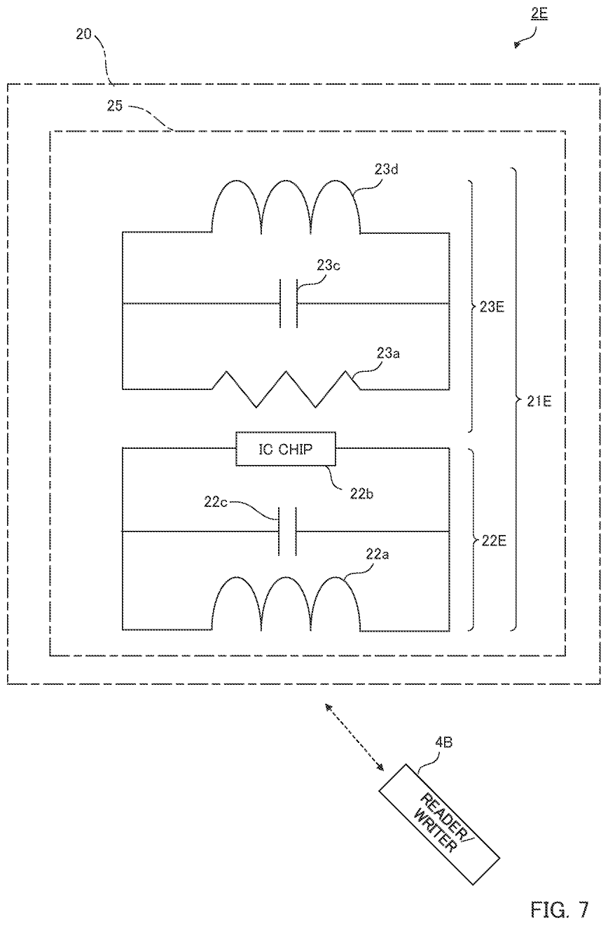

An RFID system, an RFID tag and a container of Embodiment 6 of the present disclosure are different from those of Embodiment 4 only in configurations of the reader/writer and the RFID tag as components of the RFID system, and other configurations are the same as those of Embodiment 4. Configurations of the RFID tag and the reader/writer of Embodiment 6 of the present disclosure are described below with reference to FIG. 7. FIG. 7 is a schematic view illustrating a configuration of the RFID tag of Embodiment 6 of the present disclosure.

Tag circuit 21E of RFID tag 2E of the present embodiment includes RFID circuit 22E and heating circuit 23E, which are provided independently of (separately from) each other. RFID tag 2E of the present embodiment is different from tag 2C of Embodiment 4 RFID illustrated in FIG. 5 in that RFID circuit 22E and heating circuit 23E are provided with capacitors 22c and 23c.

In RFID circuit 22E, capacitor 22c is provided in parallel with antenna 22a and IC chip 22b between antenna 22a and IC chip 22b. In heating circuit 23E, capacitor 23c is provided in parallel with antenna 23d and heater device 23a between antenna 23d and heater device 23a.

As described above, the resonance frequency of a circuit changes depending on the electrical capacitance of the capacitor. In view of this, circuits 22E and 23E are provided with capacitors 22c and 23c with a predetermined electrical capacitance so as to adjust the resonance frequencies of circuits 22E and 23E to the frequencies different from each other.

As described above in Embodiment 3, reader/writer 48 is configured to switch the frequency of carrier wave Ws between first frequency f1, which is the resonance frequency of RFID circuit 22E, and second frequency f2, which is the resonance frequency of heating circuit 23E.

When reader/writer 4B reads information from RFID tag 2E, reader/writer 4B oscillates carrier wave Ws with the frequency set to first frequency f1. When reader/writer 4B receives reflection wave Wr associated with read information (when the information is successfully read) from RFID tag 2E in response to this oscillation of carrier wave Ws, the frequency of carrier wave Ws is thereafter maintained at first frequency f1. On the other hand, when reader/writer 48 has not received reflection wave Wr associated with read information (when no reflection wave Wr itself has been detected) from RFID tan 2E in response to the oscillation of carrier wave Ws, reader/writer 4B switches the frequency of carrier wave Ws to second frequency f2 once and oscillates it for a predetermined time, and then, resets the frequency to first frequency f1.

Note that RFID circuit 22E may be provided with a PTC thermistor that stops the operation of heating circuit 23E when the temperature of RFID circuit 22E abnormally increases.

Other configurations are the same as those of RFID tag 2C of Embodiment 4, and therefore the description thereof is omitted.

### 6-2. Operation and Effect

After reading or writing of information from/to RFID tag 2E has been succeeded once, heating by heating circuit 23E is stopped, and thereafter only RFID circuit 22E is driven. Thus, when reading or writing of information from/to RFID tag 2E is continued, excessive heating of IC chip 22b can be prevented, and the thermal denaturation of sample 100 in the container can be suppressed.

In addition, since antenna 22a of RFID circuit 22E and antenna 23d of heating circuit 23E are provided independently of each other, the inductance values of antennas 22a and 23d can be independently arbitrarily set. Thus, in comparison with the case where an antenna is shared, resonance frequency f1 of RFID circuit 22E and resonance frequency f2 of heating circuit 23E can be more freely set to values sufficiently different from each other with the combination of capacitors 22c and 23c provided in respective circuits 22E and 23E. In this manner, it is possible to operate RFID circuit 22E and heating circuit 23E completely independently, and to set the frequency f1 and frequency f2 arbitrarily to frequencies in the frequency band that can be used in each country according to the Radio Law and other laws and regulation.

### 7. Embodiment 7

### 7-1. Configuration

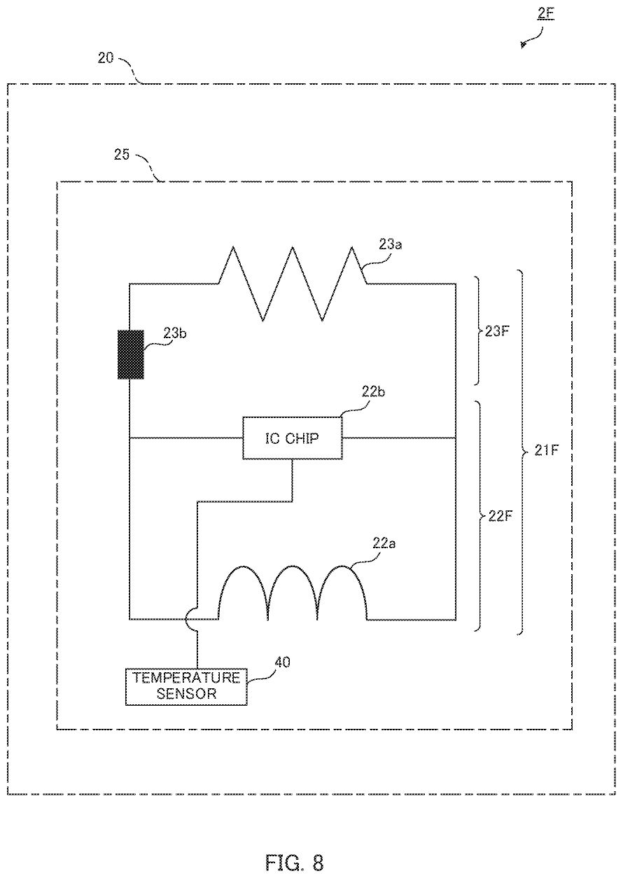

An RFID system, an RFID tag and a container of Embodiment 7 of the present disclosure are different from those of Embodiment 2 only in a configuration of the RFID tag as the component of the RFID system, and other configurations are the same as those of the embodiments. A configuration of the RFID tag of Embodiment 7 of the present disclosure is described below with reference to FIG. 8. FIG. 8 is a schematic view illustrating a configuration of the RFID tag of Embodiment 7 of the present disclosure.

Tag circuit 21F of RFID tag 2F of the present embodiment includes RFID circuit 22F and heating circuit 23F. RFID tag 2F of the present embodiment is different from RFID tag 2A of Embodiment 2 in that it is electrically connected to IC chip 22b in RFID circuit 22F, and temperature sensor 40 is provided at a position thermally separated from IC chip 22b, PTC thermistor 23b and heater device 23a.

Normally, IC chip 22b is mounted on base material 20 on which an antenna pattern (antenna 22a) is formed. The antenna pattern has a certain size according to the required inductance value. As such, by disposing temperature sensor 40 on the side opposite to IC chip 22b, PTC thermistor 23b and heater device 23a with the antenna pattern therebetween, it can be disposed with a certain distance from IC chip 22b, PTC thermistor 23b and heater device 23a. That is, temperature sensor 40 can be thermally separated from IC chip 22b, PTC thermistor 23b and heater device 23a. In addition, temperature sensor 40 may be disposed near sandwich IC chip 22b with a heat insulator therebetween. In any case, the configuration is not limited as long as temperature sensor 40 can be disposed at a position thermally separated from the thermally coupled IC chip 22b, PTC thermistor 23b and heater device 23a. Note that the position where temperature sensor 40 is thermally separated from IC chip 22b, PTC thermistor 23b and heater device 23a is a position where temperature sensor 40 can accurately detect the ambient temperature without being affected by the heat of IC chip 22b. PTC thermistor 23b and heater device 23a.

When IC chip 22b operates by receiving carrier wave Ws, IC chip 22b measures the temperature of a region around RFID tag 2F (tag circuit 21F) using connected temperature sensor 40. IC chip 22b, PTC thermistor 23b and heater device 23a may have been heated through an operation of heater device 23a in the case of an ultra-low temperature at which IC chip 22b does not operate. As such, when temperature sensor 40 is not located at a position thermally separated from IC chip 22b. PTC thermistor 23b and heater device 23a, the temperature value (temperature information) representing the temperature value of a region around RFID tag 2F and container 3 (see FIG. 1) to which RFID tag 2F is pasted may not be measured.

Regarding the temperature information measured by temperature sensor 40, RFID tag 2F modulates and transmits reflection wave Wr together with ID information when returning the ID information, and thus reader/writer 4 (see FIG. 1) can acquire the temperature information of a region around RFID tag 2F, for example. Reader/writer 4 stores the measured temperature information together with the current time.

In addition, RFID tag 2F may not send back the temperature information measured by temperature sensor 40 immediately after the temperature measurement, and may store the temperature information in the storage region in IC chip 22b. In this case, reader/writer 4 preliminarily transmits, to RFID tag 2F, carrier wave Ws including the current time information i.e., the time at which the temperature measurement is performed, so as not to lose the time when the temperature measurement was performed. In this manner, RFID tag 2F can store the temperature information together with the current time information, or more specifically, the current time information at the time point when the temperature was measured by temperature sensor 40. In this case, when reader/writer 4 reads information including temperature information from RFID tag 2F, RFID tag 2F transmits the temperature information and the time information in linkage (associated) with each other.

Other configurations are the same as those of RFID tag 2A of Embodiment 2, and therefore the description thereof is omitted.

Note that temperature sensor 40 is disposed between base material 20 and heat insulating sheet 25 in FIG. 8, but temperature sensor 40 may be provided on base material 20 at a position separated from heat insulating sheet 25.

### 7-2. Operation and Effect

With the above-mentioned configuration, temperature sensor 40 is disposed at a position thermally separated from IC chip 22b, PTC thermistor 23b, and heater device 23a, and thus the temperature information representing a region around RFID tag 2F or container 3 (see FIG. 1) to which RFID tag 2F is pasted can be correctly measured even when IC chip 22b and the like are heated by heater device 23a.

In addition, since RFID tag 2F measures temperature information and sends hack the temperature information to reader/writer 4, reader/writer 4 can link the temperature information and the current time information held by reader/writer 4. Likewise, even in the case where RFID tag 2F records the temperature information once and reader/writer 4 reads the temperature information later, the current time information and the temperature information can be linked when reader/writer 4 transmits the current time information to RFID tag 2F in the above-mentioned manner.

### 8. Modification

The present disclosure is not limited to the above-mentioned embodiments and various modifications may be made.

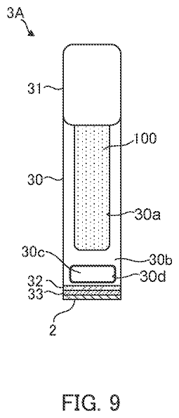

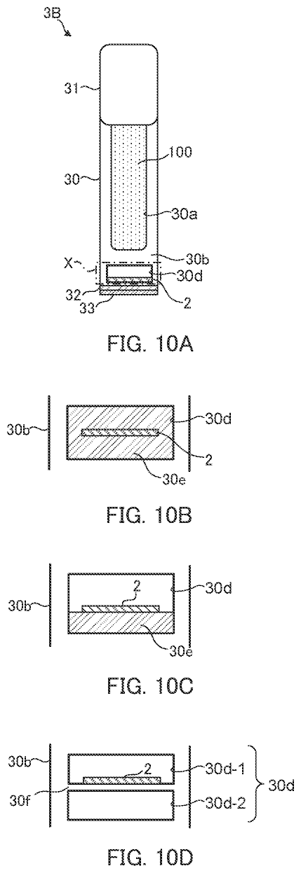

(1) With reference to FIGS. 9 to 12B, various modifications of the container are described below. FIGS. 9 to 12B are schematic sectional views illustrating configurations of various modifications of the container. FIGS. 10B to 10D are enlarged views of part X of FIG. 10A. Note that FIGS. 9 to 12B illustrate a case where RFID tag 2 is used, but RFID tags 2A to 2F may be used in place of RFID tag 2.

(1-1)

Container 3A illustrated in FIG. 9 further includes heat insulating layer 30c inside bottom portion 30b. Bottom portion 30b is located between housing part 30a that houses sample 100 and RFID tag 2 attached to bottom portion 30b. This heat insulating layer 30c is formed by filling hollow part 30d formed inside bottom portion 30b with air. In this manner, the heat transmission from RFID tag 2 to sample 100 is further suppressed.

Other configurations are the same as those of container 3 illustrated in FIG. 1, and therefore the description thereof is omitted.

(1-2)

In container 3B illustrated in FIG. 10A, RFID tag 2 is disposed in hollow part 30d provided in bottom portion 30b instead of being disposed at the bottom surface of bottom portion 30b of container main body 30. The interior of hollow part 30d is filled with air, and this air forms a heat insulating layer for heat insulation between sample 100 and RFID tag 2 in hollow part 30d. Other configurations are the same as those of container 3 illustrated in FIG. 1, and therefore the description thereof is omitted.

Part X of container 3B illustrated in FIG. 10A, i.e., hollow part 30d may be configured as illustrated in FIGS. 10B 10C, and 10D.

In the configuration illustrated in FIG. 10B, hollow part 30d is filled with heat insulator 30e. This heat insulator 30e forms a heat insulating layer. This heat insulator 30e surrounds RFID tag 2 disposed in hollow part 30d.

In the configuration illustrated in FIG. 10C, heat insulator 30e is provided up to approximately lower half of hollow part 30d. This heat insulator 30e forms a heat insulating layer. RFID tag 2 is attached to the top surface of this heat insulator 30e.

In the configuration illustrated in FIG. 10D, partition wall 30f is provided in hollow part 30d. With this partition wall 30f, hollow part 30d is divided into upper chamber 30d-1 and lower chamber 30d-2. RFID tag 2 is attached to the top surface of partition wall 30f, i.e., the bottom surface of upper chamber 30d-1. Upper chamber 30d-1 and lower chamber 30d-2 are filled with air, and upper chamber 30d-1 and lower chamber 30d-2 form. respective heat insulating layers.

Normally, sample 100 is stored in a state where it is frozen using liquid nitrogen of an ultra-low temperature (approximately −196° C.). According to the configuration illustrated in FIGS. 10A to 10D, RFID tag 2 is disposed in container main body 30, and thus RFID tag 2 can be prevented from making contact with the liquid nitrogen of an ultra-low temperature. Thus, RFID tag 2 can be prevented from being damaged due to overcooling by contact with liquid nitrogen. Likewise, RFID tags 2 can be prevented from being damaged by collisions with external objects while the container is being handled.

(1-3)

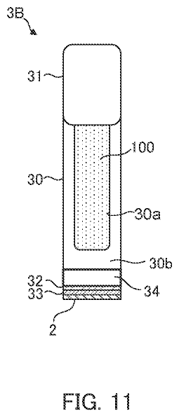

In the configuration illustrated in FIG. 11, container 38 further includes detachable attaching member 34 at bottom portion 30b. RFID tag 2 is fixed to the bottom surface of attaching member 34 with heat insulating layer 32 and shielding layer 33 therebetween.

Attaching member 34 is not limited to a particular container main body 30, and is attached to other container main bodies 30. Thus, single RFID tag 2 may be attached to a plurality of container main bodies 30.

(1-4)

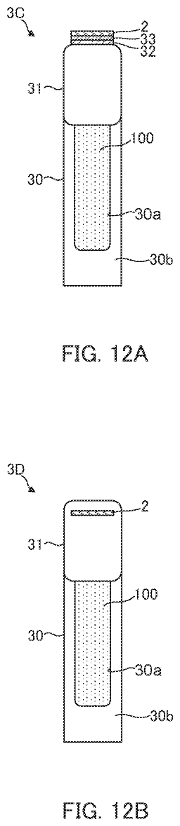

In each of containers 3C and 313 illustrated in FIGS. 12A and 12B, RFID tag 2 is attached to lid 31.

In container 3C illustrated in FIG. 12A, READ tag 2 is attached to the top surface of lid 31 with heat insulating layer 32 and shielding layer 33 therebetween. Lid 31 is relatively long in the vertical direction, and therefore the distance between RFID tag 2 attached to the top surface of lid 31 and sample 100 housed in container main body 30 is long. Thus, the heating of sample 100 with the heat generated at RFID tag 2 can be suppressed. In addition, since lid 31 is detachable to/from container main body 30, it is not limited to specific container main body 30, and may be attached to other container main bodies 30 as with attaching member 34 of container 38 illustrated in FIG. 11. Thus, single RFID tag 2 can be attached to a plurality of container main bodies 30. In this case, lid 31 constitutes the attaching member of an embodiment of the present disclosure.

in container 3D illustrated in FIG. 12B, RFID tag 2 is embedded inside lid 31, and thus in addition to the operation and effect of container 3C illustrated in FIG. 12A, damages due to direct contact with liquid nitrogen of an ultra-low temperature or other objects can be prevented.

(2) In containers 3, 3A, 3B, 3C and 3D illustrated in FIGS. 1, 9, 10A to 10D, 11, 12A and 12B, the positions of heat insulating layer 32 and shielding layer 33 illustrated in the drawings may be reversed. In addition, if there is no risk of the influence on sample 100 depending on the type of sample 100, the thickness (height) of bottom portion 30b and the thickness (height) of lid 31, at least one of heat insulating layer 32 and shielding layer 33 may be omitted.

(3) The objects to be housed in containers 3, 3A, 3B, 3C and 3D are not limited to samples, and may also be chemical agent or food, for example.

(4) In the above-mentioned embodiments, the communication apparatus of the embodiment of the present disclosure is a reader/writer, i.e., a member that can read and write information from/to an RFID tag, but the communication apparatus is not limited to this. It suffices that the communication apparatus can perform at least one of reading and writing of information from/to an RFID tag.

(5) In the above-mentioned Embodiment 7, a humidity sensor, a vibration sensor, a chemical sensor, a gas sensor or an optical sensor may be connected to IC chip 22b in place of temperature sensor 40 or together with temperature sensor 40, such that IC chip 22b acquires detection information from the sensor. When a humidity sensor, a vibration sensor, a chemical sensor, a gas sensor or an optical sensor requires its surrounding temperature information for measurement, temperature sensor 40 may be additionally connected to IC chip 22b. In this case, it suffices that the temperature information measured by temperature sensor 40 is output to the humidity sensor, the vibration sensor, the chemical sensor, the gas sensor or the optical sensor through IC chip 22b. As in the above-mentioned Embodiment 7, preferably, temperature sensor 40 is disposed at a position thermally separated from IC chip 22b, PIC thermistor 23b and heater device 23a so that the temperature information can be measured without being affected by the heat. In addition, the humidity sensor, the vibration sensor, the chemical sensor, the gas sensor or the optical sensor also requires temperature information for measurement, and therefore it is preferable that they be disposed at a position thermally separated from IC chip 22b, PTC thermistor 23b and heater device 23a, as with temperature sensor 40.

(Additional Remark 1)

An RFID tag comprising:
an antenna configured to generate power from received carrier waves composed of electromagnetic waves;
a semiconductor integrated circuit configured to operate with the power supplied from the antenna; and
a heater device configured to generate heat with the power supplied from the antenna to heat the semiconductor integrated circuit.

(Additional Remark 2)

The RFID tag according to additional remark 1,
wherein the antenna is a single antenna; and
wherein an RFID circuit comprising the semiconductor integrated circuit and a heating circuit comprising the heater device are configured to share the antenna and configured integrally with each other.

(Additional Remark 3)

The RFID tag according to additional remark 2, wherein the heating circuit does not operate when a temperature of the semiconductor integrated circuit is greater than a threshold value.

(Additional Remark 4)

The RFID tag according to additional remark 2, wherein the heating circuit further comprises an impedance device connected in series with the heater device and thermally coupled with the semiconductor integrated circuit, wherein an impedance of the impedance device decreases with decreasing temperature.

(Additional Remark 5)

The RFID tag according to additional remark 4, wherein the impedance device is a PTC thermistor device.

(Additional Remark 6)

The RFID tag according to additional remark 1,
wherein as the antenna, a first antenna configured to supply power to the semiconductor integrated circuit and a second antenna configured to supply power to the heater device are provided; and
wherein an RFID circuit comprising the semiconductor integrated circuit and the first antenna, and a heating circuit comprising the heater device and the second antenna are provided independently of each other.

(Additional Remark 7)

The RFID tag according to additional remark 6, wherein a first resonance frequency that is a resonance frequency of the RFID circuit, and a second resonance frequency that is a resonance frequency of the heating circuit are different from each other.

(Additional Remark 8)

The RFID tag according to additional remark 6, wherein the heating circuit does not operate when a temperature of the semiconductor integrated circuit is greater than a threshold value.

(Additional Remark 9)

The RFID tag according to additional remark 6, wherein the heating circuit further comprise an impedance device connected in series with the heater device and thermally coupled with the semiconductor integrated circuit, wherein an impedance of the impedance device decreases with decreasing temperature.

(Additional Remark 10)

The RFID tag according to additional remark 9, wherein the impedance device is a PTC thermistor device.

(Additional Remark 11)

The RFID tag according to additional remark 2, wherein the heating circuit does not comprise a switching device comprising a semiconductor.

(Additional Remark 12)

The RFID tag according to additional remark 1, further comprising a heat insulator configured to cover the semiconductor integrated circuit and the heater device.

(Additional Remark 13)

The RFID tag according to additional remark 1, wherein the RFID tag further comprises a temperature sensor device at a position thermally separated from the semiconductor integrated circuit and the heater device.

(Additional Remark 14)

The RFID tag according to additional remark 13,
wherein the temperature sensor device is electrically connected with the semiconductor integrated circuit; and
wherein temperature measurement is performed when the semiconductor integrated circuit operates with power supply from the antenna.

(Additional Remark 15)

The RFID tag according to additional remark 14, wherein after the temperature measurement is performed when the semiconductor integrated circuit operates with the power supply from the antenna, measured temperature information is transmitted via the antenna.

(Additional Remark 16)

The RFID tag according to additional remark 14, wherein after the temperature measurement is performed when the semiconductor integrated circuit operates with the power supply from the antenna, temperature information is recorded in a storage region of the semiconductor integrated circuit.

(Additional Remark 17)

The RFID tag according to additional remark 1, wherein the RFID tag further comprises at least one sensor of a humidity sensor, a vibration sensor, a chemical sensor, a gas sensor, and an optical sensor.

(Additional Remark 18)

The RFID tag according to additional remark 17, wherein
the at least one sensor is electrically connected with the semiconductor integrated circuit, and
the at least one sensor performs a measurement when the semiconductor integrated circuit operates with power supply from the antenna.

(Additional Remark 19)

The RFID tag according to additional remark 18, wherein when the semiconductor integrated circuit operates with the power supply from the antenna, the measurement is performed by the at least one sensor, and measured information is transmitted via the antenna.

(Additional Remark 20)

The RFID tag according to additional remark 18, wherein when the semiconductor integrated circuit operates with the power supply from the antenna, the measurement is performed by the at least one sensor, and measured information is recorded in a storage region of the semiconductor integrated circuit.

(Additional Remark 21)

An RFID system comprising:
the RFID tag according to additional remark 1; and
a communication apparatus configured to oscillate the carrier waves composed of the electromagnetic waves, and perform at least one of an operation of writing information to the RFID tag and an operation of reading information from the RFID tag.

(Additional Remark 22)

An RFID system comprising:
the RFID tag according to additional remark 7; and
a communication apparatus configured to switch oscillation at the first resonance frequency and oscillation at the second resonance frequency, and perform at least one of an operation of reading information or an operation of writing information by operating the RFID tag by performing oscillation at the first resonance frequency,
wherein when the communication apparatus fails to perform at least one of the operation of reading information or the operation of writing information by operating the RFID tag by performing the oscillation at the first resonance frequency, the communication apparatus switches to oscillation at the second resonance frequency.

(Additional Remark 23)

The RFID system according to additional remark 22, wherein after performing the oscillation at the second resonance frequency for a predetermined time, the communication apparatus switches back to the oscillation at the first resonance frequency to operate the RFID tag, and again attempts to perform at least one of the operation of reading information or the operation of writing information.

(Additional Remark 24)

An RFID system comprising:
the RFID tag according to additional remark 16; and
a communication apparatus configured to oscillate the carrier waves composed of the electromagnetic waves, and perform at least one of an operation of writing information to the RFID tag and an operation of reading information from the RFID tag,
wherein when the communication apparatus oscillates the carrier waves, the communication apparatus adds time information indicating present time to the carrier waves, and
wherein the RFID tag records the temperature information and the time information indicating present time in the storage region of the semiconductor integrated circuit.

(Additional Remark 25)

The RFID system according to additional remark 24, wherein when the communication apparatus reads information from the RFID tag, the communication. apparatus reads the time information recorded together with the temperature information

(Additional Remark 26)

An RFID system comprising:
the RFID tag according to additional remark 20; and
a communication apparatus configured to oscillate the carrier waves composed of the electromagnetic waves, and perform at least one of an operation of writing information to the RFID tag and an operation of reading information from the RFID tag,
wherein when the communication apparatus oscillates the carrier waves, the communication apparatus adds time information indicating present time to the carrier waves, and
the RFID tag records the measured information and the time information indicating present time in the storage region of the semiconductor integrated circuit.

(Additional Remark 27)

The RFID system according to additional remark 26, wherein when the communication apparatus reads the measured information from the RFID tag, the communication apparatus reads the time information recorded together with the measured information.

(Additional Remark 28)

A container comprising:
a container main body comprising a housing part; and
the RFID tag according to additional remark 1 attached to the container main body,

(Additional Remark 29)

The container according to additional remark 28, further comprising a heat insulating layer provided between the housing part and the RFID tag.

(Additional Remark 30)

The container according to additional remark 28, further comprising a shielding layer provided between the housing part and the RFID tag, wherein the shielding layer does not allow the carrier waves to transmit through the shielding layer.

(Additional Remark 31)

The container according to additional remark 28, further comprising an attaching member that is detachable to/from the container main body,
wherein the RFID tag is provided in the attaching member.

This application is a continuation (in-part) of International Patent Application No. PCT/JP2019/046593, filed on Nov. 28, 2019, the disclosure of which is incorporated herein by reference in its entirety, International Patent Application No. PCP/JP2019/046593 is entitled to (or claims) the benefit of Japanese Patent Application No. 2019-001468, filed on Jan. 8, 2019, the disclosure of which is incorporated herein by reference in its entirety.

### INDUSTRIAL APPLICABILITY

The present disclosure is favorably utilized for an RFID tag and an RFID system and a container using the RFD tag.

### REFERENCE SIGNS LIST

1 RFID system

2, 2A, 2B, 2C, 2D, 2E, 2F RFID tag

3, 3A 3B, 3C, 3D Container

4, 4B Reader/writer (Communication apparatus)

5 Information processing apparatus

20 Base material

21, 21A, 21B, 21C, 21D, 21E, 21F Tag circuit

22, 22B, 22C, 22E, 22F RFID Circuit

22a, 23d Antenna

22b Semiconductor integrated circuit (IC chip)

22c Capacitor

23, 23A, 23B, 23C, 23D, 23E, 23F Heating circuit

23a Heater device

23b PTC thermistor device (Impedance device)

23c Capacitor

25 Heat insulating sheet (Heat insulator)

30 Container main body

30a Housing part

30b Bottom portion

30c Heat insulating layer

30d Hollow part

30d-1 Upper chamber

30d-2 Lower chamber

30e Heat insulator

30f Partition wall

31 Lid

32 Heat insulating layer

33 Shielding layer

34 Attaching member

40 Temperature sensor

100 Sample

C, C1, C2 Electrical capacitance of capacitor

F Resonance frequency

F1 First frequency

F2 Second frequency

L Inductance

T1 Temperature of IC chip 22b

T0 Threshold value

Wr Reflection wave

Ws Carrier wave

1. An RFID tag comprising:
an antenna configured to generate power from received carrier waves composed of electromagnetic waves;
a semiconductor integrated circuit configured to operate with the power supplied from the antenna; and
a heater device configured to generate heat with the power supplied from the antenna to heat the semiconductor integrated circuit.

2. The RFID tag according to claim 1,
wherein the antenna is a single antenna; and
wherein an RFID circuit comprising the semiconductor integrated circuit and a heating circuit comprising the heater device are configured to share the antenna and configured integrally with each other.

3. The RFID tag according to claim 2, wherein the heating circuit does not operate when a temperature of the semiconductor integrated circuit is greater than a threshold value.

4. The RFID tag according to claim 2, wherein the heating circuit further comprises an impedance device connected in series with the heater device and thermally coupled with the semiconductor integrated circuit, wherein an impedance of the impedance device decreases with decreasing temperature.

5. The RFID tag according to claim 4, wherein the impedance device is a PTC thermistor device.

6. The RFID tag according to claim 1,
wherein as the antenna, a first antenna configured to supply power to the semiconductor integrated circuit and a second antenna configured to supply power to the heater device are provided; and
wherein an RFID circuit comprising the semiconductor integrated circuit and the first antenna, and a heating circuit comprising the heater device and the second antenna are provided independently of each other.

7. The RFID tag according to claim 6, wherein a first resonance frequency that is a resonance frequency of the RFID circuit, and a second resonance frequency that is a resonance frequency of the heating circuit are different from each other.

8. The RFID tag according to claim 6, wherein the heating circuit does not operate when a temperature of the semiconductor integrated circuit is greater than a threshold value.

9. The RFID tag according to claim 6, wherein the heating circuit further comprise an impedance device connected in series with the heater device and thermally coupled with the semiconductor integrated circuit, wherein an impedance of the impedance device decreases with decreasing temperature.

10. The RFID tag according to claim 9, wherein the impedance device is a PTC thermistor device.

11. The RFID tag according to claim 2, wherein the heating circuit does not comprise a switching device comprising a semiconductor.

12. The RFID tag according to claim 1, further comprising a heat insulator configured to cover the semiconductor integrated circuit and the heater device.

13. The RFID tag according to claim 1, wherein the RFID tag further comprises a temperature sensor device at a position thermally separated from the semiconductor integrated circuit and the heater device,

14. The RFID tag according to claim 13,
wherein the temperature sensor device is electrically connected with the semiconductor integrated circuit; and
wherein temperature measurement is performed when the semiconductor integrated circuit operates with power supply from the antenna.

15. The RFID tag according to claim 14, wherein after the temperature measurement is performed when the semiconductor integrated circuit operates with the power supply from the antenna, measured temperature information is transmitted via the antenna.

16. The RFID tag according to claim 14, wherein after the temperature measurement is performed when the semiconductor integrated circuit operates with the power supply from the antenna, temperature information is recorded in a storage region of the semiconductor integrated circuit.

17. An RFID system comprising:
the RFID tag according to claim 1; and
a communication apparatus configured to oscillate the carrier waves composed of the electromagnetic waves, and perform at least one of an operation of writing information to the RFID tag and an operation of reading information from the RFID tag.

18. An RFID system comprising:
the RFID tag according to claim 7; and
a communication apparatus configured to switch oscillation at the first resonance frequency and oscillation at the second resonance frequency, and perform at least one of an operation of reading information or an operation of writing information by operating the RFID tag by performing oscillation at the first resonance frequency,
wherein when the communication apparatus fails to perform at least one of the operation of reading information or the operation of writing information by operating the RFID tag by performing the oscillation at the first resonance frequency, the communication apparatus switches to oscillation at the second resonance frequency.

19. The RFID system according to claim 18, wherein after performing the oscillation at the second resonance frequency for a predetermined time, the communication apparatus switches back to the oscillation at the first resonance frequency to operate the RFID tag, and again attempts to perform at least one of the operation of reading information or the operation of writing information.

20. A container comprising:
a container main body comprising a housing part; and
the RFID tag according to claim 1 attached to the container main body.
